(19) United States
(12) Patent Application Publication
(10) Pub. No.: US 2022/0292530 A1
(43) Pub. Date: Sep. 15, 2022

(54) ARRANGEMENT PLANNING APPARATUS AND METHOD OF SAME

(71) Applicant: Hitachi, Ltd., Tokyo (JP)

(72) Inventor: Naoki SHIMODE, Tokyo (JP)

(73) Assignee: Hitachi, Ltd., Tokyo (JP)

(21) Appl. No.: 17/641,283

(22) PCT Filed: Jan. 28, 2021
(86) PCT No.: PCT/JP2021/003119

§ 371 Date: Mar. 8, 2022

(30) Foreign Application Priority Data
Mar. 27, 2020 (JP) 2020-056934

(51) Int. Cl. G06Q 30/02; G06Q 10/04

(52) U.S. Cl. CPC G06Q 30/0202; G06Q 10/047

(57) ABSTRACT

An arrangement planning apparatus includes a demand prediction unit which sequentially predicts an occurrence time point and an occurrence spot of demand for a moving resource along a time course, a first data conversion unit which analyzes each prediction result by the demand prediction unit based on a spatiotemporal division system, in which a size of an area where the moving resource is movable and a length of a time range in which the moving resource moves are defined, and converts each prediction result by the demand prediction unit into plural groups of first moving resource management data including the areas and the time ranges, a spatiotemporal division unit which extracts a specific group among combinations of the areas and the time ranges in the plural groups of first moving resource management data, changes the area and the time range which belong to the extracted specific group, and updates the spatiotemporal division system with this change, and a second data conversion unit which applies the spatiotemporal division system updated by the spatiotemporal division unit to each prediction result by the demand prediction unit and converts each prediction result by the demand prediction unit into plural groups of second moving resource management data including the areas and the time ranges.

### CROSS-REFERENCE TO RELATED APPLICATION

This application claims priority pursuant to 35 U.S.C. § 119 from Japanese Patent Application No. 2020-056934, filed on Mar. 27, 2020, the entire disclosure of which is incorporated herein by reference.

### BACKGROUND

### Technical Field

The present invention relates to an arrangement planning apparatus and a method of same which plan arrangement of moving resources including vehicles.

### Related Art

In Japanese Patent Application Laid-Open Publication No. 2019-028489 (Patent Literature 1), a prediction apparatus has been suggested which predicts demand for vehicles, as an apparatus which efficiently dispatches a vehicle or the like, for example. Patent Literature 1 discloses a technique about a prediction apparatus which includes an acquisition unit acquiring area information indicating a situation of a predetermined area, the area information changing along a time course, and a prediction unit predicting demand about a predetermined target in a predetermined area based on the area information acquired by the acquisition unit.

A technique disclosed in Patent Literature 1 can properly predict demand about a predetermined target but is not sufficient for optimization of arrangement of moving resources including vehicles for demand fluctuating by the minute. That is, because precision of demand prediction for moving resources has to be maintained to be highly precise in order to optimize arrangement of the moving resources, it is required to appropriately manage areas where the moving resources are movable and time ranges in which the moving resources move in conformity with demand for the moving resources.

### SUMMARY OF THE INVENTION

An object of the present invention is to manage areas where moving resources are movable and time ranges in which the moving resources move in conformity with demand for the moving resources.

To solve the above problems, the present invention provides an arrangement planning apparatus including: a demand prediction unit which sequentially predicts an occurrence time point and an occurrence spot of demand for a moving resource along a time course; a first data conversion unit which analyzes each prediction result by the demand prediction unit based on a spatiotemporal division system, in which a size of an area where the moving resource is movable and a length of a time range in which the moving resource moves are defined, and converts each prediction result by the demand prediction unit into plural groups of first moving resource management data including the areas and the time ranges; a spatiotemporal division unit which extracts a specific group among combinations of the areas and the time ranges in the plural groups of first moving resource management data which result from conversion by the first data conversion unit, changes the area and the time range which belong to the extracted specific group, and updates the spatiotemporal division system with changes in the area and the time range; and a second data conversion unit which applies the spatiotemporal division system updated by the spatiotemporal division unit to each prediction result by the demand prediction unit and converts each prediction result by the demand prediction unit into plural groups of second moving resource management data including the areas and the time ranges.

In the present invention, areas where moving resources are movable and time ranges in which the moving resources move can be managed in conformity with demand for the moving resources.

### BRIEF DESCRIPTION OF THE DRAWINGS

FIG. 1 is a configuration diagram of an arrangement planning apparatus according to the present embodiment.

FIG. 2 is a configuration diagram of movement demand data according to the present embodiment.

FIG. 3 is a configuration diagram of moving resource position information according to the present embodiment.

FIG. 4 is a configuration diagram of space division system data according to the present embodiment.

FIG. 5 is a configuration diagram of time division system data according to the present embodiment.

FIG. 6 is a configuration diagram of learning data according to the present embodiment.

FIG. 7 is a flowchart for explaining a demand prediction update process according to the present embodiment.

FIG. 8 is a flowchart for explaining a simulator execution process according to the present embodiment.

FIG. 9 is a flowchart for explaining a space division update process according to the present embodiment.

FIG. 10 is a flowchart for explaining a time division update process according to the present embodiment.

### DETAILED DESCRIPTION OF THE INVENTION

An embodiment of an arrangement planning apparatus according to the present invention will hereinafter be described based on drawings.

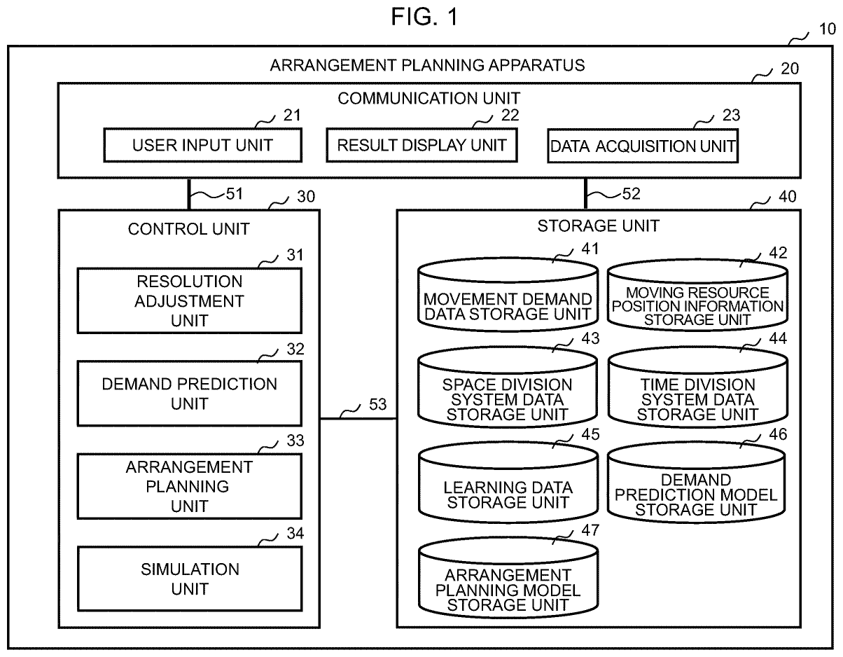

FIG. 1 is a configuration diagram of an arrangement planning apparatus according to the present embodiment. In FIG. 1, an arrangement planning apparatus 10 includes a communication unit 20, a control unit 30, and a storage unit 40, and each of the units is coupled to each other via buses 51, 52, and 53. In this case, the arrangement planning apparatus 10 can be configured with a computer device which includes a CPU (central processing unit), an input device, an output device, a communication device, and a storage device.

The CPU functions as the control unit (central processing device) 30 which integrally controls an action of the whole device. The input device is configured with a keyboard or a mouse and functions as a user input unit 21 through which data and information by an operation by a user are input. The output device is configured with a display or a printer and functions as a result display unit 22 which displays an arrangement plan, a prediction result, a division result, and so forth, for example, as processing results by the control unit 30. Further, the communication device is configured to include an NIC (network interface card) for connecting with a wireless LAN or a wired LAN and functions as a data acquisition unit 23 which acquires data from a communication target of the arrangement planning apparatus 10. Moreover, the storage device is configured with storage media such as a RAM (random access memory) and a ROM (read-only memory) and functions as a storage unit 40 which stores data, information, and so forth as processing targets of the control unit 30.

The communication unit 20 includes the user input unit 21 through which data and information by an operation by the user are input, the result display unit 22 which displays an arrangement plan, a prediction result, a division result, and so forth, for example, as processing results by the control unit 30, and the data acquisition unit 23 which acquires data from a communication target of the arrangement planning apparatus 10.

The control unit 30 includes a resolution adjustment unit 31, a demand prediction unit 32, an arrangement planning unit 33, and a simulation unit 34.

The storage unit 40 includes a movement demand data storage unit 41, a moving resource position information storage unit 42, a space division system data storage unit 43, a time division system data storage unit 44, a learning data storage unit 45, a demand prediction model storage unit 46, and an arrangement planning model storage unit 47.

In order to adjust resolution in a spatiotemporal division system (spatiotemporal division method) in which a size of an area where moving resources are movable and a length of a time range in which the moving resource move are defined, the resolution adjustment unit 31 adjusts the size of resolution (spatial resolution) of space division system data stored in the space division system data storage unit 43 (the size of an area where a moving resource is movable) and adjusts the size of resolution (time resolution) of time division system data stored in the time division system data storage unit 44 (the length of a time range in which a moving resource moves).

The demand prediction unit 32 sequentially predicts occurrence time points and occurrence spots of demand for the moving resources along the time course. Specifically, the demand prediction unit 32 sequentially predicts what kind of movement demand is present for the moving resource, for example, a moving body (vehicle) such as an ambulance and records each prediction result as movement demand data in the movement demand data storage unit 41.

The arrangement planning unit 33 plans a place and a time at which the moving resource is arranged based on each prediction result by the demand prediction unit 32 and manages a content of the plan as an arrangement planning model. For example, the arrangement planning unit 33 generates an arrangement plan about in which areas (spaces) and to what extent the moving resources are arranged based on each prediction result by the demand prediction unit 32 and records the generated arrangement plan as the arrangement planning model (arrangement policy) in the arrangement planning model storage unit 47.

The simulation unit 34 functions as a simulator which conducts a simulation about arrangement efficiency of the moving resources in plural spatiotemporal division systems based on demand prediction models, arrangement planning models, and spatiotemporal division systems (spatiotemporal division methods).

The resolution adjustment unit 31, the demand prediction unit 32, the arrangement planning unit 33, and the simulation unit 34 can also be configured with software resources. In a case where the resolution adjustment unit 31, the demand prediction unit 32, the arrangement planning unit 33, and the simulation unit 34 are configured with software resources, various kinds of programs for causing the CPU to function as the resolution adjustment unit 31, the demand prediction unit 32, the arrangement planning unit 33, and the simulation unit 34 (a resolution adjustment program, a demand prediction program, an arrangement planning program and a simulation program) are stored in the storage unit 40, the CPU activates the various kinds of programs which are expanded in the RAM, and a function of each of the units can thereby be realized.

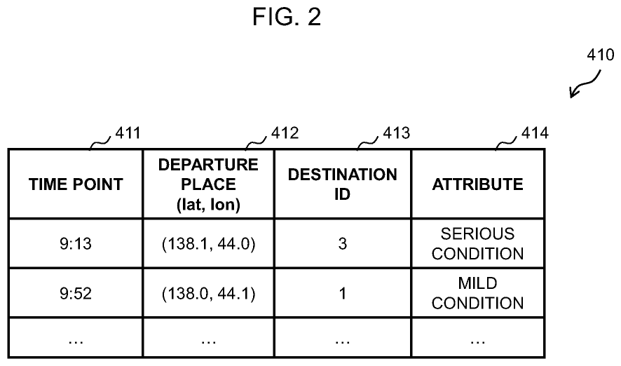

FIG. 2 is a configuration diagram of the movement demand data according to the present embodiment. In FIG. 2, movement demand data 410 are data to be stored in the movement demand data storage unit 41 and are configured with a time point 411, a departure place 412, a destination ID 413, and an attribute 414.

In the time point 411, information indicating a time point when the movement demand occurs is stored. In the departure place 412, information specifying a departure place of a moving resource (moving body) at a time when the movement demand occurs is stored. In the destination ID 413, information of an identifier (numerical value) which uniquely identifies a destination of a moving resource at a time when the movement demand occurs is stored. In the attribute 414, information indicating urgency or the like for the moving resource is stored. For example, in a case where the moving resource is an ambulance and a person to be transported by the ambulance is in a serious condition, information of “serious condition” is stored in the attribute 414. Note that in the attribute 414, the number of persons who are transported by the moving resources (number of persons) can also be stored. Further, the movement demand data 410 are managed as data indicating achievements or assumed data.

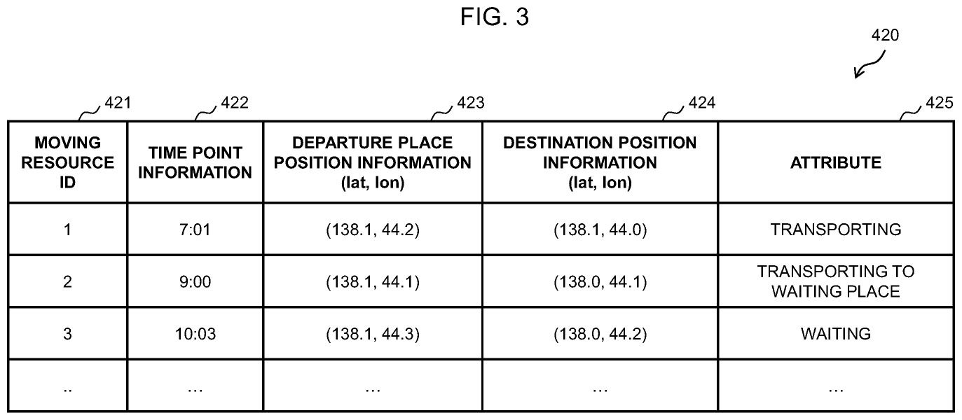

FIG. 3 is a configuration diagram of moving resource position information according to the present embodiment. In FIG. 3, moving resource position information 420 is information to be stored in the moving resource position information storage unit 42 and is configured with a moving resource ID 421, time point information 422, departure place position information (lat, lon) 423, destination position information (lat, lon) 424, and an attribute 425.

In the moving resource ID 421, information of an identifier (numerical value) which uniquely identifies a moving resource is stored. In the time point information 422, information indicating a time point when the movement demand for the moving resource occurs is stored. In the departure place position information (lat, lon) 423, as information specifying a position of a departure place of a moving resource at a time when the movement demand occurs, information indicating the latitude and longitude of the departure place is stored. In the destination position information (lat, lon) 424, as information specifying a position of a destination of a moving resource at a time when the movement demand occurs, information indicating the latitude and longitude of the destination is stored. In the attribute 425, information indicating a state or the like of the moving resource is stored. For example, in a case where the moving resource is an ambulance and the ambulance is transporting a person, information of “transporting” is stored in the attribute 425.

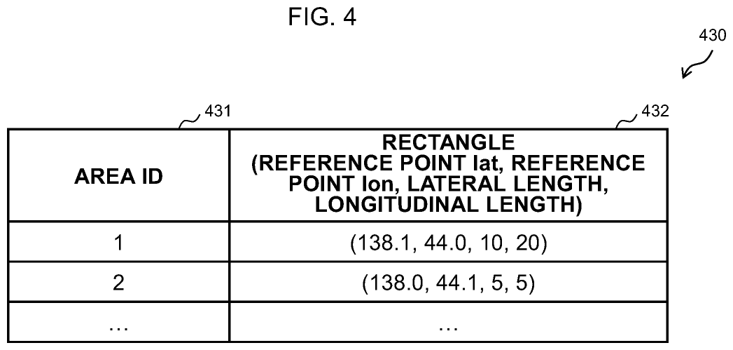

FIG. 4 is a configuration diagram of the space division system data according to the present embodiment. In FIG. 4, space division system data 430 are data to be managed by the spatiotemporal division system (spatiotemporal division method) and are stored in the space division system data storage unit 43 in order to manage the area (space) where the moving resource is movable. The space division system data 430 is configured with an area ID 431 and a rectangle (reference point lat, reference point lon, lateral length, longitudinal length) 432.

In the area ID 431, information of an identifier (numerical value) which uniquely identifies each area (space) where the moving resource is arranged is stored. In the rectangle (reference point lat, reference point lon, lateral length, longitudinal length) 432, as information indicating reference points of each area (space), information indicating the latitude and longitude of each area (space) is stored, and as information indicating the size of each area (space) in the reference points, information indicating the lateral length and the longitudinal length of each area (space) is stored. Note that the space division system data 430 are configured with plural sets of data, the sizes of spatial resolution (spatial resolution units) of which are the same or different and the sizes of areas (spaces) of which are the same or different.

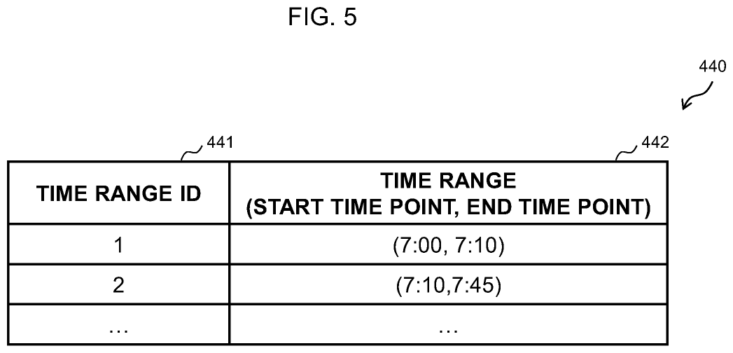

FIG. 5 is a configuration diagram of the time division system data according to the present embodiment. In FIG. 5, time division system data 440 are data to be managed by the spatiotemporal division system (spatiotemporal division method) and are stored in the time division system data storage unit 44. The time division system data 440 are configured with a time range ID 441 and a time range (start time point, end time point) 442.

In the time range ID 441, information of an identifier (numerical value) which uniquely identifies a time range in which the moving resource moves is stored. In the time range (start time point, end time point) 442, information indicating a start time point when the movement by the moving resource is started and an end time point when the movement by the moving resource is finished is stored. Note that because the information to be stored in the time range (start time point, end time point) 442 is managed as a unit of time resolution, for example, in a case where the time resolution is managed in units of 10 minutes or in units of 30 minutes, information of “10 minutes” or “30 minutes” can be stored, as information indicating a time resolution unit, in the time range 442 instead of the start time point and the end time point. Further, the time division system data 440 are configured with plural sets of data, the sizes of time period (time range) (time resolution units) of which are the same or different.

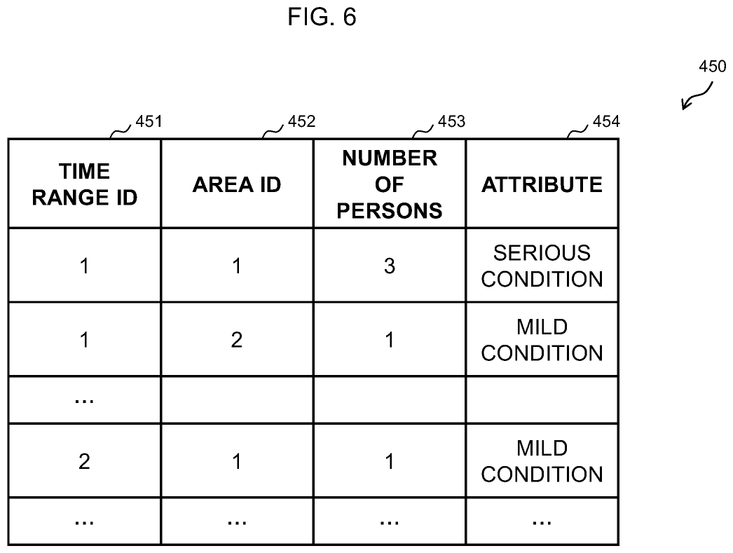

FIG. 6 is a configuration diagram of learning data according to the present embodiment. In FIG. 6, learning data 450 are data to be stored as moving resource management data for managing the moving resources in the learning data storage unit 45 and are configured with a time range ID 451, an area ID 452, the number of persons 453, and an attribute 454. The learning data 450 are data obtained by collecting plural sets of movement demand data 410 which indicate that demand occurs at certain time points and at certain spots and by applying statistical processing to the plural sets of collected movement demand data 410. In this case, the learning data 450 are data obtained by learning in which time range, to which area, and how many persons the moving resources have moved based on plural sets of movement demand data 410 as each prediction result by the demand prediction unit 32 and are managed as statistical data which have a certain time width and a certain spatial size (area). Note that as for the learning data 450, for example, each prediction result by the demand prediction unit 32 is analyzed based on the spatiotemporal division system (spatiotemporal division method) in which the size of an area where the moving resources are movable and the length of a time range in which the moving resources move are defined, and each prediction result by the demand prediction unit 32 can thereby be obtained as data including an area and a time range (first moving resource management data).

In the time range ID 451, information of an identifier (numerical value) which uniquely identifies a time range in which demand for the moving resource occurs is stored. In the area ID 452, information of an identifier (numerical value) which uniquely identifies an area where demand for the moving resource occurs is stored. In the number of persons 453, information indicating the number of transported persons (learning target persons) which is specified by the time range and area in which demand for the moving resource occurs is stored. In the attribute 454, information indicating a state of the transported person is stored. For example, in a case where the transported person is in a serious condition, information of “serious condition” is stored in the attribute 454.

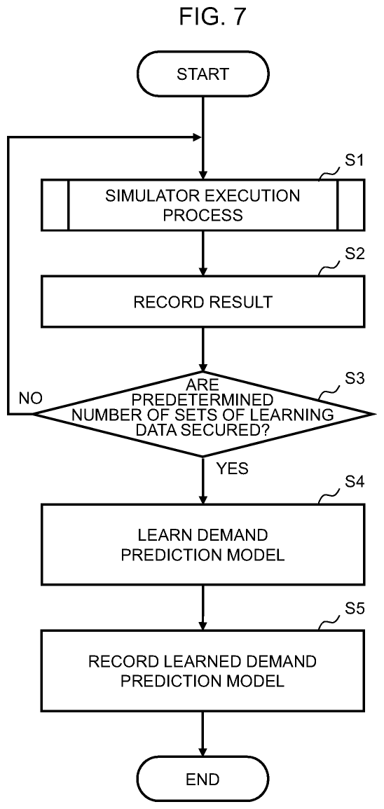

FIG. 7 is a flowchart for explaining a demand prediction update process according to the present embodiment. In FIG. 7, this process is started when the control unit 30 activates the demand prediction unit 32. First, the demand prediction unit 32 executes a simulator execution process, for example, in a cycle of one second while changing combinations of the size of the area (the size of the spatial resolution unit) and the size of the time period (the size of the time range or the size of the time resolution unit) (S1). The demand prediction unit 32 records the learning data 450 as a result of the simulator execution process in the learning data storage unit 45 (S2) and thereafter determines whether or not a predetermined number of sets of learning data are secured from results of the simulator execution process (S3). On one hand, in a case where a negative determination result is obtained in step S3, that is, the number of sets of learning data 450 is insufficient, the demand prediction unit 32 returns to a process in step S1 and repeats processes in steps S1 to S3.

On the other hand, in a case where an affirmative determination result is obtained in step S3, that is, the number of sets of learning data 450 reaches the predetermined number, the demand prediction unit 32 learns the demand prediction model based on the learning data 450 recorded in the learning data storage unit 45 (S4), records the demand prediction model, which has been learned, as the learned demand prediction model in the demand prediction model storage unit 46 (S5), and thereafter finishes the process in this routine.

Note that in a case where an initial arrangement planning model (arrangement policy) or an updated arranged planning model (arrangement policy) is acquired from the arrangement planning model storage unit 47 before the simulator execution process is executed in step S1, a process of updating the initial arrangement planning model or of again updating the updated arrangement planning model based on the movement demand data 410 and the learning data 450 can also be added to the process subsequent to step S5.

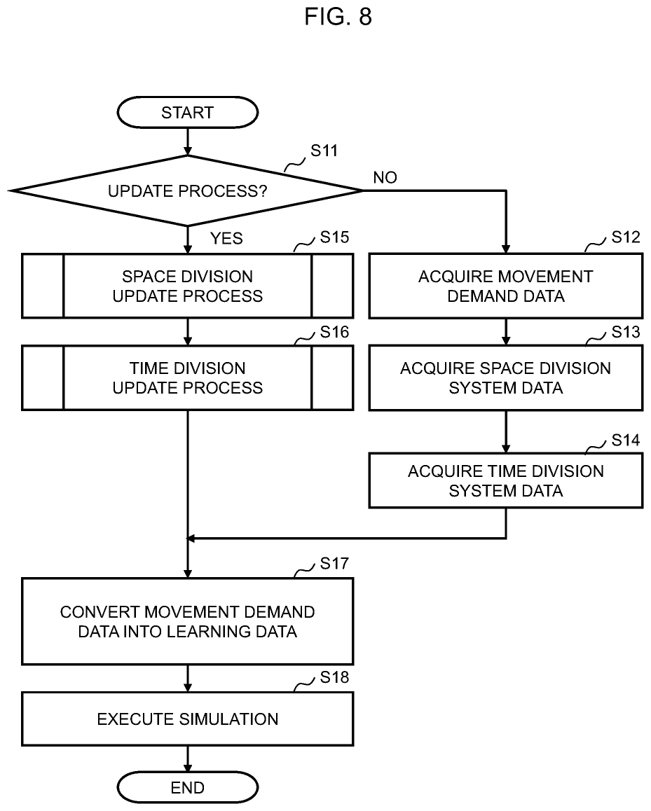

FIG. 8 is a flowchart for explaining the simulator execution process according to the present embodiment. This process is a subroutine indicating specific contents of step S1. In FIG. 8, the demand prediction unit 32 determines whether or not an update process is performed (S11). The demand prediction unit 32 moves to a process in step S12 in a case where it is determined that the update process is not performed but moves to a process in step S15 in a case where it is determined that the update process is performed.

On one hand, in step S12, the demand prediction unit 32 acquires the movement demand data 410 from the movement demand data storage unit 41. Next, the demand prediction unit 32 acquires the space division system data 430 from the space division system data storage unit 43 (S13), thereafter acquires the time division system data 440 from the time division system data storage unit 44 (S14), and thereafter moves to a process in step S17.

On the other hand, in a case where it is determined that the update process is performed in step S11, a space division update process is executed in step S15, and a time division update process is thereafter executed in step S16, the process in step S17 is executed.

In step S17, the demand prediction unit 32 converts the movement demand data 410 into the learning data 450 based on the space division system. Subsequently, the demand prediction unit requests the simulation unit 34 to perform a process. In response to this, the simulation unit 34 applies the arrangement planning model (arrangement policy) acquired from the arrangement planning model storage unit 47 to the learning data 450 resulting from conversion in step S17, applies the moving resource position information 420 acquired from the moving resource position information storage unit 42 to the above learning data 450, executes a simulation for calculating next movement demand for and arrangement effects on the moving resources (S18), transfers execution results of the simulation to the demand prediction unit 32, and thereafter finishes the process in this routine.

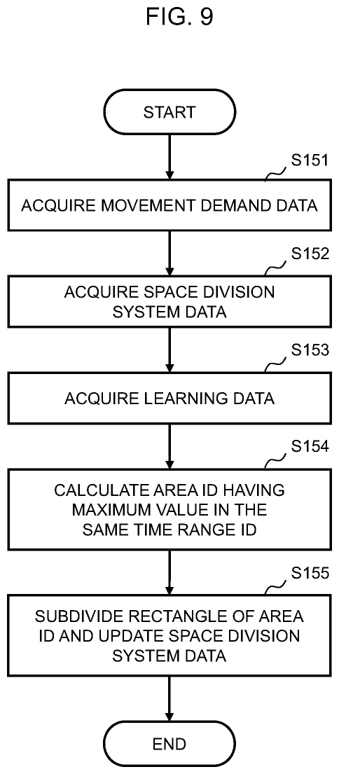

FIG. 9 is a flowchart for explaining the space division update process according to the present embodiment. This process is a subroutine indicating specific contents of step S15 in FIG. 8. In FIG. 9, the demand prediction unit 32 acquires the movement demand data 410 from the movement demand data storage unit 41 (S151), next acquires the space division system data 430 from the space division system data storage unit 43 (S152), and further acquires the learning data 450 from the learning data storage unit 45 (S153).

Subsequently, based on the acquired learning data 450, the demand prediction unit 32 calculates the area ID in which a value by a predetermined calculation formula (for example, a formula for calculating a standard deviation) becomes a maximum, for example, the area ID in which the variance of demand in the learning data 450 as statistical data is high in the same time range ID (S154).

Next, the demand prediction unit 32 subdivides the rectangle of the area ID calculated in step 5154, updates the space division system data 430, records the updated space division system data 430 in the space division system data storage unit 43 (S155), and finishes the process in this routine. In this case, the demand prediction unit 32 refers to the space division system data 430 based on the calculated area ID and performs subdivision by dividing data which belong to the rectangle 432 corresponding to the calculated area ID 431 into data of plural areas. For example, an area which has longitudinal and lateral lengths of 10 km is subdivided into plural divided areas each of which has longitudinal and lateral lengths of 1 km.

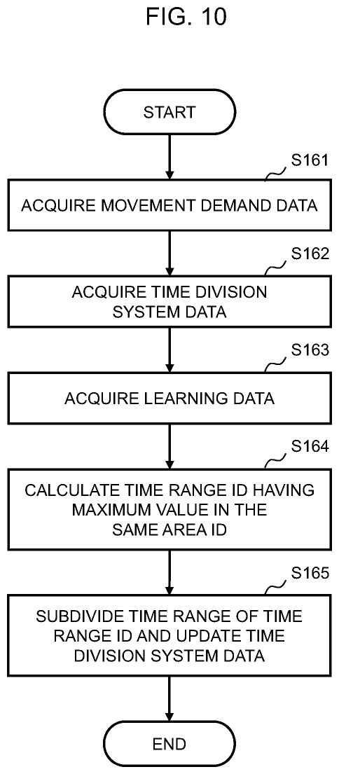

FIG. 10 is a flowchart for explaining the time division update process according to the present embodiment. This process is a subroutine indicating specific contents of step S16 in FIG. 8. In FIG. 10, the demand prediction unit 32 acquires the movement demand data 410 from the movement demand data storage unit 41 (S161), next acquires the time division system data 440 from the time division system data storage unit 44 (S162), and further acquires the learning data 450 from the learning data storage unit 45 (S163).

Subsequently, based on the acquired learning data 450, the demand prediction unit 32 calculates the time range ID in which a value by a predetermined calculation formula (for example, a formula for calculating a standard deviation) becomes a maximum, for example, the time range ID in which the variance of demand in the learning data 450 as statistical data is high in the same area ID (S164).

Next, the demand prediction unit 32 subdivides the time range of the calculated time range ID, updates the time division system data 440, records the updated time division system data 440 in the time division system data storage unit 44 (S165), and finishes the process in this routine. In this case, the demand prediction unit 32 refers to the time division system data 440 based on the calculated time range ID and subdivides data which belong to the time range 442 corresponding to the calculated time range ID 441 into plural time ranges. For example, data (time range) in units of 10 minutes are subdivided into plural data (divided time ranges) in units of 1 minute.

In the present embodiment, a description is made about a case where the demand prediction unit 32 processes the processes in FIG. 7 to FIG. 10 in cooperation with the resolution adjustment unit 31, the arrangement planning unit 33, and the simulation unit 34; however, in a case where the demand prediction unit 32 executes processes in steps S11, S12, S13, S14, and S17 in FIG. 8 in the course of execution of the processes in steps S1 to S3 in FIG. 7, instead of the demand prediction unit 32, a first data conversion unit (not illustrated) can execute those processes. In this case, the first data conversion unit has a function of analyzing each prediction result (movement demand data) by the demand prediction unit 32 based on the spatiotemporal division system (spatiotemporal division method), in which the size of an area where the moving resources are movable and the length of a time range in which the moving resources move are defined, and of converting each prediction result by the demand prediction unit 32 into plural groups of learning data (first moving resource management data) 450 including areas and time ranges.

Further, in a case where the demand prediction unit 32 executes processes in steps S11, S15, and S16 in FIG. 8, processes in steps S151 to S155 in FIG. 9, and processes in steps S161 to S165 in FIG. 10 in the course of execution of the processes in steps S1 to S3 in FIG. 7, instead of the demand prediction unit 32, a spatiotemporal division unit (not illustrated) can execute those processes. In this case, the spatiotemporal division unit has a function of extracting a specific group (a group of a maximum area in the same time range and a maximum time range in the same area) among combinations of areas and time ranges in the plural groups of learning data (first moving resource management data) based on the plural groups of learning data (first moving resource management data) 450 resulting from conversion by the first data conversion unit, of changing the area and time range which belong to the extracted specific group, and of updating the spatiotemporal division system with the changes in the area and time range.

In this case, when the spatiotemporal division system is updated, the spatiotemporal division unit can subdivide the size of the area which belongs to the specific group, change the area into plural divided areas, subdivide the length of the time range which belongs to the specific group, and change the time range into plural divided time ranges. Accordingly, the time range and area which belong to the specific group can be managed by subdividing those. Further, the spatiotemporal division unit can extract the area where demand for the moving resources becomes a maximum in the same time range as the area which belongs to the specific group from the plural groups of learning data (first moving resource management data) 450 and extract the time range in which demand for the moving resources becomes a maximum in the same area as the time range which belongs to the specific group. Accordingly, management can be performed by selecting the time range and area which belong to the group where demand for the moving resources becomes a maximum.

Furthermore, in a case where the demand prediction unit 32 executes the process in step S17 after the processes in steps S11, S15, and S16 in FIG. 8 in the course of execution of the processes in steps S1 to S3 in FIG. 7, instead of the demand prediction unit 32, a second data conversion unit (not illustrated) can execute those processes. In this case, the second data conversion unit has a function of applying the spatiotemporal division system updated by the spatiotemporal division unit to each prediction result (movement demand data) by the demand prediction unit 32 and of converting each prediction result (movement demand data) by the demand prediction unit 32 into plural groups of learning data (second moving resource management data) including areas and time ranges. In this case, the learning data (second moving resource management data) can be obtained which are subdivided in accordance with the updated spatiotemporal division system. Further, the arrangement planning model stored in the arrangement planning model storage unit 47 and the moving resource position information stored in the moving resource position information storage unit 42 are applied to the subdivided learning data, and the moving resources can thereby optimally be arranged. Moreover, it becomes possible to generate a highly precise demand prediction model by learning the movement demand model of the moving resources based on the subdivided learning data.

Note that the first data conversion unit, the spatiotemporal division unit, and the second data conversion unit can be arranged as hardware resources in the control unit 30 and can be arranged as software resources (programs) in the storage unit 40.

In the present embodiment, the areas where the moving resources are movable and the time ranges in which the moving resources move can be managed in conformity with demand for the moving resources. As a result, it becomes possible to optimize the arrangement of the moving resources and to generate a highly precise demand prediction model.

Note that the present invention is not limited to the above-described embodiment and includes various modifications. For example, the spatiotemporal division unit also can extract a group where the time period from an occurrence of movement of the moving resource to a settlement becomes a minimum as a specific group from the plural groups of learning data (moving resource management data), subdivide the size of the area which belongs to the specific group, change the area into plural divided areas, subdivide the length of the time range which belongs to the specific group, and change the time range into plural divided time ranges. In this case, management can be performed by subdividing the area and time range which belong to the group where the time period from an occurrence of movement of the moving resource to a settlement becomes a minimum. Further, the above-described embodiment is described in detail for easy understanding of the present invention, and the present invention is not necessarily limited to embodiments which include all of the described configurations. Further, as for a portion of the configurations of the embodiment, addition, omission, and substitution about other configurations are possible.

Further, a portion or all of the above configurations, functions, and so forth may be realized with hardware by design with an integrated circuit or the like, for example. Further, the above configurations, functions, and so forth may be realized with software by interpretation and execution of programs realizing each function by a processor. Information such as programs, tables, and files realizing the functions can be recorded in recording devices such as a memory, a hard disk, and an SSD (solid state drive) or recording media such as an IC (integrated circuit) card, an SD (secure digital) memory card, and a DVD (digital versatile disc).

What is claimed is:

1. An arrangement planning apparatus comprising:
a demand prediction unit which sequentially predicts an occurrence time point and an occurrence spot of demand for a moving resource along a time course;
a first data conversion unit which analyzes each prediction result by the demand prediction unit based on a spatiotemporal division system, in which a size of an area where the moving resource is movable and a length of a time range in which the moving resource moves are defined, and converts each prediction result by the demand prediction unit into plural groups of first moving resource management data including the areas and the time ranges;
a spatiotemporal division unit which extracts a specific group among combinations of the areas and the time ranges in the plural groups of first moving resource management data, changes the area and the time range which belong to the extracted specific group, and updates the spatiotemporal division system with changes in the area and the time range; and
a second data conversion unit which applies the spatiotemporal division system updated by the spatiotemporal division unit to each prediction result by the demand prediction unit and converts each prediction result by the demand prediction unit into plural groups of second moving resource management data including the areas and the time ranges.

2. The arrangement planning apparatus according to claim 1, wherein
the spatiotemporal division unit
subdivides a size of the area which belongs to the specific group, changes the area into plural divided areas, subdivides a length of the time range which belongs to the specific group, and changes the time range into plural divided time ranges when the spatiotemporal division system is updated.

3. The arrangement planning apparatus according to claim 1, wherein
the spatiotemporal division unit
extracts an area where demand for the moving resource becomes a maximum in the same time range as an area which belongs to the specific group from the plural groups of first moving resource management data and extracts a time range in which demand for the moving resource becomes a maximum in the same area as a time range which belongs to the specific group.

4. The arrangement planning apparatus according to claim 1, wherein
the spatiotemporal division unit
extracts a group where a time period from an occurrence of movement of the moving resource to a settlement becomes a minimum as the specific group from the plural groups of first moving resource management data, subdivides a size of the area which belongs to the specific group, changes the area into plural divided areas, subdivides a length of the time range which belongs to the specific group, and changes the time range into plural divided time ranges.

5. The arrangement planning apparatus according to claim 1, further comprising:
an arrangement planning unit which plans a place and a time at which the moving resource is arranged based on each prediction result by the demand prediction unit and manages a content of the plan as an arrangement planning model;
a moving resource position information storage unit which stores moving resource position information about positions of the moving resource in plural time ranges; and
a demand prediction model learning unit which applies the arrangement planning model and the moving resource position information to the plural groups of second moving resource management data which result from conversion by the second data conversion unit and learns a demand prediction model of the moving resource.

6. An arrangement planning method comprising:
a demand prediction step of sequentially predicting an occurrence time point and an occurrence spot of demand for a moving resource along a time course;
a first data conversion step of analyzing each prediction result by the demand prediction step based on a spatiotemporal division system, in which a size of an area where the moving resource is movable and a length of a time range in which the moving resource moves are defined, and of converting each prediction result by the demand prediction step into plural groups of first moving resource management data including the areas and the time ranges;
a spatiotemporal division step of extracting a specific group among combinations of the areas and the time ranges in the plural groups of first moving resource management data which result from conversion by the first data conversion step, of changing the area and the time range which belong to the extracted specific group, and of updating the spatiotemporal division system with changes in the area and the time range; and
a second data conversion step of applying the spatiotemporal division system updated by the spatiotemporal division step to each prediction result by the demand prediction step and of converting each prediction result by the demand prediction step into plural groups of second moving resource management data including the areas and the time ranges.

7. The arrangement planning method according to claim 6, wherein
in the spatiotemporal division step,
when the spatiotemporal division system is updated, a size of the area which belongs to the specific group is subdivided, the area is changed into plural divided areas, a length of the time range which belongs to the specific group is subdivided, and the time range is changed into plural divided time ranges.

8. The arrangement planning method according to claim 6, wherein
in the spatiotemporal division step,
an area where demand for the moving resource becomes a maximum in the same time range is extracted as an area which belongs to the specific group from the plural groups of first moving resource management data, and a time range in which demand for the moving resource becomes a maximum in the same area is extracted as a time range which belongs to the specific group.

9. The arrangement planning method according to claim 6, wherein
in the spatiotemporal division step,
a group where a time period from an occurrence of movement of the moving resource to a settlement becomes a minimum is extracted as the specific group from the plural groups of first moving resource management data, a size of the area which belongs to the specific group is subdivided, the area is changed into plural divided areas, a length of the time range which belongs to the specific group is subdivided, and the time range is changed into plural divided time ranges.

10. The arrangement planning method according to claim 6, further comprising:
an arrangement planning step of planning a place and a time at which the moving resource is arranged based on each prediction result by the demand prediction step and of managing a content of the plan as an arrangement planning model;
a moving resource position information storage step of storing moving resource position information about positions of the moving resource in plural time ranges; and
a demand prediction model learning step of applying the arrangement planning model and the moving resource position information to the plural groups of second moving resource management data which result from conversion by the second data conversion step and of learning a demand prediction model of the moving resource.
